(19) United States
(12) Patent Application Publication
(10) Pub. No.: US 2020/0342331 A1
(43) Pub. Date: Oct. 29, 2020

(54) CLASSIFICATION TREE GENERATION METHOD, CLASSIFICATION TREE GENERATION DEVICE, AND CLASSIFICATION TREE GENERATION PROGRAM

(71) Applicant: NEC CORPORATION, Tokyo (JP)

(72) Inventor: Takao TAKENOUCHI, Tokyo (JP)

(73) Assignee: NEC CORPORATION, Tokyo (JP)

(21) Appl. No.: 16/962,117

(22) PCT Filed: Jan. 15, 2018
(86) PCT No.: PCT/JP2018/000878

§ 371 Date: Jul. 14, 2020

(51) Int. Cl. G06N 5/00; G06F 16/22; G06F 16/28; G06N 5/04; G06N 20/00

(52) U.S. Cl. CPC G06N 5/003; G06F 16/2246; G06N 20/00; G06N 5/04; G06F 16/285

(57) ABSTRACT

A classification tree generation device 10 that selects, from a plurality of classification condition candidates, a new classification condition to be added to a classification tree, which is a prediction model expressed in a tree structure formed from one or more nodes representing classification conditions, said device comprising: a first computation unit 11 that computes information gain relating to the classification condition candidate; a second computation unit 12 that computes, as a cost relating to the classification condition candidate, a value representing the magnitude of the smallest difference among differences between the classification condition candidate and each of the classification conditions included in the classification tree; and a selection unit 13 that selects, as the new classification condition, the classification condition candidate from among the plurality of classification condition candidates that has the largest value among values obtained by subtracting the computed cost from the computed information gain.

### TECHNICAL FIELD

The present invention relates to a classification tree generation method, a classification tree generation device, and a classification tree generation program.

### BACKGROUND ART

A classification tree (decision tree) is a prediction model that draws conclusions regarding a target value of an arbitrary item from observation results for the arbitrary item (for example, see Non Patent Literature (NPL) 1). Examples of existing methods for generating a classification tree include Iterative Dichotomiser 3 (ID3) disclosed in NPL 2 and C4.5 disclosed in NPL 3. In addition, Patent Literature (PTL) 1 discloses a data classification device that generates a decision tree in consideration of classification accuracy and computational cost when classifying data into categories using the decision tree.

The algorithm of an existing method for generating a classification tree will be described with reference to FIG. 13. FIG. 13 is an explanatory diagram showing variables of a generation target classification tree. The vertical axis of the graph shown in the left of FIG. 13 represents an attribute A (age). The horizontal axis of the graph shown in the left of FIG. 13 represents an attribute B (sex). The attribute A (age) and the attribute B (sex) are explanatory variables of a classification tree to be generated in this example.

In addition, the graph shown in the left of FIG. 13 is plotted with “X” and “Y”. “X” represents a product X, and “Y” represents a product Y. The product X and product Y are objective variables of the classification tree to be generated in this example.

The process for generating the classification tree corresponds to the process for splitting the area on the graph shown in the left of FIG. 13. As shown in the right of FIG. 13, the area on the graph is split a plurality of times. Specifically, the first splitting is performed to split the area into the upper and lower areas, and, then, the second splitting is performed to split the upper and lower areas each into the left and right areas.

The splitting process shown in the right of FIG. 13 is performed by, for example, a classification tree generation device shown in FIG. 14. FIG. 14 is a block diagram showing a configuration example of a general classification tree generation device.

A classification tree generation device 900 shown in FIG. 14 includes a classification tree learning-data storage unit 910, a Score computation unit 920, a splitting point determination unit 930, a splitting execution unit 940, and a splitting point storage unit 950. In addition, the Score computation unit 920 includes an InfoGain computation unit 921.

The classification tree generation device 900 performs the splitting process shown in the right of FIG. 13 according to the flowchart shown in FIG. 15. FIG. 15 is a flowchart showing the operation in the classification tree generation process of the classification tree generation device 900.

The input for the splitting process shown in FIG. 15 is the splitting target area. First, the Score computation unit 920 enumerates splitting point candidates relating to the explanatory variables in the splitting target area stored in the classification tree learning-data storage unit 910 as splitting candidates. The Score computation unit 920 inputs all the enumerated splitting candidates of all the explanatory variables in “all splitting candidates” (step S001).

If all the splitting candidates are 0 (True in step S002), the classification tree generation device 900 performs a splitting process on another splitting target area (step S009). If all the splitting candidates are not 0 (False in step S002), the Score computation unit 920 extracts, from all the splitting candidates, one splitting candidate whose Score has not been computed. That is, the classification tree generation device 900 enters a splitting candidate loop (step S003).

The InfoGain computation unit 921 of the Score computation unit 920 computes, for the extracted splitting candidate, InformationGain (information gain) as Score (step S004). The InformationGain is InformationGain when the splitting target area is split at the extracted splitting candidate. The InfoGain computation unit 921 inputs the computed Score to the splitting point determination unit 930.

Then, the splitting point determination unit 930 determines whether the input Score is the largest among computed Scores in the splitting process (step S005). If the input Score is not the largest (No in step S005), the process of step S007 is performed.

If the input Score is the largest (Yes in step S005), the splitting point determination unit 930 updates the splitting point in the splitting target area with the splitting candidate extracted in step S003 (step S006). Then, the splitting point determination unit 930 stores the updated splitting candidate in the splitting point storage unit 950.

The processes of steps S004 to S006 are repeated while there is a splitting candidate whose Score has not been computed among all the splitting candidates. When all the Scores of the splitting candidates among all the splitting candidates are computed, the classification tree generation device 900 exits from the splitting candidate loop (step S007).

Then, the splitting execution unit 940 splits the splitting target area at the splitting point stored in the splitting point storage unit 950 (step S008).

Then, the classification tree generation device 900 performs the splitting process using the splitting target area newly generated in step S008 as input (step S009). For example, if a first split area and a second split area are newly generated in step S008, the classification tree generation device 900 recursively performs the splitting process on the two split areas. That is, the splitting process (first split area) and the splitting process (second split area) are performed.

As described above, the classification tree generation device 900 performs the splitting process on all the splitting target area. All the areas are gradually split by recursively calling the splitting process. When there is no splitting point candidate in the area, the splitting process is terminated.

Next, a method for computing InformationGain will be described. InformationGain is a value computed as follows.

InformationGain=(Average amount of information in the area before splitting)−(Average amount of information in the area after splitting)

The algorithm for computing InformationGain in ID3 disclosed in NPL 4 is shown below. The independent variables of input are a₁, . . . , and aₙ. In addition, the possible output is stored in a set D, and the ratio at which xϵD occurs in an example set C is represented by pₓ(C).

The average amount of information M(C) for the example set C is computed as follows.

$$\begin{matrix}[ Expression 1 ] & \\ M ( C ) = - {\sum }_{x ∈ D} {p}_{x} ( C ) log {p}_{x} ( C ) & Expression ( 1 )\end{matrix}$$

Next, the example set C is split according to the value of the independent variable aᵢ, When aᵢ has m values of v₁, . . . , and vₘ, the splitting is performed as follows.

Cᵢⱼ⊂C(aᵢ=vⱼ)

The average amount of information M(Cᵢⱼ) according to the split is computed as follows.

$$\begin{matrix}[ Expression 2 ] & \\ M ( {C}_{ij} ) = - {\sum }_{x ∈ D} {p}_{x} ( {C}_{ij} ) log {p}_{x} ( {C}_{ij} ) & Expression ( 2 )\end{matrix}$$

On the basis of the computed average amount of information, the expected value Mᵢ of the average amount of information of the independent variable aᵢ is computed as follows.

$$\begin{matrix}[ Expression 3 ] & \\ {M}_{i} = M ( C ) - {\sum }_{j = 1}^{m} M ( {C}_{ij} ) \times \frac{\vert {C}_{ij} \vert}{\vert C \vert} & Expression ( 3 )\end{matrix}$$

Mᵢ computed with Expression (3) is the value corresponding to InformationGain. In the following, an example of splitting a splitting target area is split according to the splitting process shown in FIG. 15 and the above computation algorithm will be described. FIG. 16 is an explanatory diagram showing an example of a splitting process of the classification tree generation device 900.

The left of FIG. 16 shows a splitting target area. The Score computation unit 920 enumerates splitting candidates for the splitting target area shown in the left of FIG. 16 (step S001). The first to fourth candidates shown in the right of FIG. 16 are all the enumerated splitting candidates.

Then, the InfoGain computation unit 921 computes InformationGain as the Score of each splitting candidate (step S004). For example, the InfoGain computation unit 921 computes InformationGain for the first candidate as follows.

The area before splitting has seven x elements and five y elements, totaling 12 elements. The left area after the splitting at the first candidate has four x elements and four y elements, totaling eight elements. The right area after the splitting at the first candidate has three x elements and one y element, totaling four elements.

For the area in the above state, the InfoGain computation unit 921 computes InformationGain for the first candidate. First, the InfoGain computation unit 921 computes the average amount of information in the area before the splitting according to Expression (1) as follows.

(Average amount of information in the area before splitting)=−1×(7/12×log(7/12)+5/12×log(5/12))≈0.29497

Then, the InfoGain computation unit 921 computes the average amount of information in the left area after the splitting and the average information amount in the right area after the splitting according to Expression (1) as follows.

(Average amount of information in the left area after splitting)=−1×(4/8×log(4/8)+4/8×log(4/8))≈0.30103

(Average amount of information in the right area after splitting)=−1×(3/4×log(3/4)+1/4×log(1/4))≈0.244219

On the basis of the computation results, the InfoGain computation unit 921 computes the Score of the first candidate according to Expression (3) as follows.

Score=InformationGain=(average amount of information in the area before splitting)−(average amount of information in the area after splitting)=(average amount of information in the area before splitting)−(8/12×(average amount of information in the left area after splitting)+4/12×(average amount of information in the right area after splitting)=0.29497−0.282093=0.012877

The InfoGain computation unit 921 computes the Score of each splitting candidate as described above. The computed Scores of the splitting candidates are 0.012877 for the first candidate, 0.003 for the second candidate, 0.002 for the third candidate, and 0.003 for the fourth candidate. Since the splitting candidate having the largest Score is the first candidate, the splitting point determination unit 930 determines the splitting point as the first candidate.

Since the splitting point is determined as the first candidate, the splitting execution unit 940 splits the splitting target area shown in FIG. 16 at the first candidate (step S008). The splitting target area split at the first candidate is shown in FIG. 17. FIG. 17 is an explanatory diagram showing another example of the splitting process of the classification tree generation device 900.

As shown in FIG. 17, the splitting target area is split into the left area and the right area enclosed by broken lines. Then, the classification tree generation device 900 recursively performs the splitting process on the left area (step S009). The classification tree generation device 900 further recursively performs the splitting process on the right area (step S009).

FIG. 18 is an explanatory diagram showing another example of the splitting process of the classification tree generation device 900. As shown in FIG. 18, the splitting candidate in the right area is only the fifth candidate. Thus, the splitting execution unit 940 splits the splitting target area enclosed by the broken line shown in FIG. 18 by the fifth candidate (step S008). Since there is no splitting candidate in the two areas after the splitting at the fifth candidate, the splitting process in the right area is terminated.

FIG. 19 is an explanatory diagram showing another example of the splitting process of the classification tree generation device 900. As shown in FIG. 19, the splitting candidates in the left area are the sixth candidate, the seventh candidate, and the eighth candidate. The Scores of the splitting candidates computed by the above method are 0.0 for the sixth candidate, 0.014 for the seventh candidate, and 0.014 for the eighth candidate. Thus, the splitting candidates with the largest Score are the seventh and eighth candidates.

If there are a plurality of splitting candidates with the largest Score, the splitting candidate to be the splitting point is randomly selected or selected in order from the top. In this example, the splitting point determination unit 930 determines the eighth candidate, which is the candidate closest to the horizontal axis, as the splitting point. Thus, the splitting execution unit 940 splits the splitting target area enclosed by the broken line shown in FIG. 19 at the eighth candidate (step S008).

FIG. 20 is an explanatory diagram showing another example of the splitting process of the classification tree generation device 900. The splitting target area shown in FIG. 20 is split by broken lines. Note that, the splitting process can be further performed on the area in the state shown in FIG. 20, but the splitting process is terminated in the state shown in FIG. 20 in this example.

FIG. 21 is an explanatory diagram showing an example of a classification tree. The classification tree shown in FIG. 21 is a classification tree generated on the basis of the splitting target area shown in FIG. 20. The classification tree shown in FIG. 21 has a depth of two. In addition, the nodes other than the leaf nodes of the classification tree shown in FIG. 21 represent classification conditions corresponding to the splitting points stored in the splitting process.

The classification conditions forming the classification tree are generated on the basis of the splitting points stored in the splitting process. For example, a classification condition “A>1” is generated for a splitting point “A=1”.

In addition, the leaf nodes of the classification tree shown in FIG. 21 represent the tendencies of products to be purchased. For example, in the case of “B>2, A>2”, all the elements in the area shown in FIG. 20 are x, and the leaf node represents “tendency to purchase the product X”. In the case of “B>2, A≤2”, the elements in the area shown in FIG. 20 are one x element and one y element, and the leaf node represents “unclear” as the tendency of a product to be purchased.

In the case of “B≤2, A>1”, more y elements are in the area shown in FIG. 20, and the leaf node represents “tendency to purchase the product Y”. In the case of “B≤2, A≤1”, more x elements are in the area shown in FIG. 20, and the leaf node represents “tendency to purchase the product X”.

The classification tree described above is used, for example, in a secret computation technology. Means for performing secret computation includes a method using the secret sharing of Ben-Or et al. disclosed in NPL 5, a method using homomorphic encryption, such as ElGamal cipher, disclosed in NPL 6, or a method using the fully homomorphic encryption proposed by Gentry disclosed in NPL 7.

The means for performing secret computation in this specification is a multi-party computation (MPC) scheme using the secret sharing by Ben-Or et al. FIG. 22 is an explanatory diagram showing an example of a secret computation technique. FIG. 22 shows a system employing the MPC scheme.

When a secret-sharing multi-party computation technique is used, a plurality of servers can dispersedly hold encrypted data and perform arbitrary computation on the encrypted data. Arbitrary computation expressed as a set of logic circuits, such as an OR circuit and an AND circuit, can theoretically be performed in a system employing the MPC scheme.

For example, as shown in FIG. 22, confidential data A is shared and held by a plurality of servers. Specifically, the confidential data A is secretly shared and held as X, Y, and Z (X and Y are random numbers) satisfying “A=X+Y+Z”.

An administrator a, an administrator b, and an administrator c cooperate, among servers, with each other to perform computation without knowing the original confidential data A, that is, perform multi-party computation. As a result of the multi-party computation, the administrator a, the administrator b, and the administrator c obtain U, V, and W, respectively.

Next, an analyst restores the computation result based on U, V, and W. Specifically, the analyst obtains a computation result R for the secretly shared data satisfying “R=U+V+W”.

In the system shown in FIG. 22, a hacker can only obtain random shared data by hacking one server. That is, data leakage due to a cyber attack is prevented, and the system security is improved. Data leakage does not occur unless, for example, administrators collude to distribute data among servers, and the analyst can safely process the data.

FIG. 23 is an explanatory diagram showing another example of the secret computation technique. FIG. 23 shows an example in which data is combined by a plurality of organizations using a secret computation technique and analyzed in a system employing the MPC scheme.

As shown in FIG. 23, the confidential data A of an organization A and the confidential data B of an organization B are each secretly shared. Specifically, the confidential data A is secretly shared as X_{A}, Y_{A}, and Z_{A}. The confidential data B is secretly shared as X_{B}, Y_{B}, and Z_{B}.

The administrator of each server performs an analysis process without disclosing the confidential data. By performing the analysis process, the analysis results of U from X_{A} and X_{B}, V from Y_{A} and Y_{B}, and W from Z_{A} and Z_{B} are obtained. Finally, the analyst restores an analysis result R on the basis of U, V, and W.

That is, as shown in FIG. 23, by using the secret computation technology to process the data for each of different organizations while the data is secretly shared, the analysis result of the combined data is obtained without disclosing the original data and contents during the computation to the outside of the organizations. Analyzing the combined data can lead to new findings that are not available from a single piece of data.

PTL 2 discloses an example of a system using the above secret computation technique.

PTL 3 discloses a performance abnormality analysis apparatus that, in a complicated network system such as a multilayer server system, analyzes and clarifies generation patterns of a performance abnormality to assist in early identifying the cause of the performance abnormality and in early resolving the abnormality.

PTL 4 discloses a data division apparatus capable of dividing multidimensional data into a plurality of clusters by appropriately reflecting tendencies other than the distance between points in the multidimensional data.

PTL 5 discloses a search decision tree generation method that enables generation of a search decision tree in which questions are positioned in consideration of the difficulty or the easiness of the questions.

### CITATION LIST

### Patent Literature

PTL 1: Japanese Patent Application Laid-Open No. 2011-028519
PTL 2: International Publication No. WO 2017/126434
PTL 3: International Publication No. WO 2007/052327
PTL 4: Japanese Patent Application Laid-Open No. 2006-330988
PTL 5: Japanese Patent Application Laid-Open No. 2004-341928

### Non Patent Literature

NPL 1: “Decision Tree”, [online], Wikipedia, [Searched on Dec. 7, 2017], Internet <https://en.wikipedia.org/wiki/%E6%B1%BA%E5%AE%9A%E6%9C%A8>
NPL 2: Quinlan J. Ross, “Induction of decision trees,” Machine learning 1.1, 1986, pages 81-106.
NPL 3: “C4.5”, [online], Wikipedia, [Searched on Dec. 7, 2017], Internet <https://en.wikipedia.org/wiki/C4.5>
NPL 4: “ID3”, [online], Wikipedia, [Searched on Dec. 7, 2017], Internet <https://en.wikipedia.org/wiki/ID3>
NPL 5: M. Ben-Or, S. Goldwasser, and A. Wigderson, “Completeness theorems for non-cryptographic fault-tolerant distributed computation (extended abstract),” 20th Symposium on Theory of Computing (STOC), ACM, 1988, pages 1-10.
NPL 6: T. E. Gamal, “A public key cryptosystem and a signature scheme based on discrete logarithms,” IEEE Transactions on Information Theory, 1985, 31 (4), pages 469-472.
NPL 7: C. Gentry, “Fully homomorphic encryption using ideal lattices,” In M. Mitzenmacher ed., Proceedings of the 41st Annual ACM Symposium on Theory of Computing, STOC 2009, ACM, 2009, pages 169-178.

### SUMMARY OF INVENTION

### Technical Problem

FIG. 24 is an explanatory diagram showing an example of a prediction process using a classification tree in a system employing the MPC scheme. The classification tree shown in the upper of FIG. 24 is the classification tree shown in FIG. 21. When a prediction process using a classification tree is performed, a business operator A inputs the classification tree shown in the upper of FIG. 24 to a system employing the MPC scheme, for example.

In addition, a business operator B inputs personal information to be used for evaluation of classification conditions of the classification tree. In the example shown in the upper of FIG. 24, the business operator B inputs the value of an attribute A and the value of an attribute B of a person who is a prediction target into the system employing the MPC scheme. For example, the business operator B inputs “B=1, A=3”.

The lower of FIG. 24 shows the prediction process of the system employing the MPC scheme. Double-lined arrows in the lower of FIG. 24 show the results that the system employing the MPC scheme has evaluated the classification conditions.

As shown in the lower of FIG. 24, the system employing the MPC scheme evaluates all the classification conditions of “B>2”, “A>1”, and “A>2” of the classification tree. In this example, the system employing the MPC scheme evaluates “B>2 as false”, “A>1 as true”, and “A>2 as true”.

On the basis of the evaluation results of all the classification conditions, the system employing the MPC scheme confirms only one route from the root node to a leaf node of the classification tree. The route from the root node of the classification tree to the leaf node “tendency to purchase product Y” according to the above evaluation results is only one route; the root node “B>2”->the node “A>1”->the leaf node “tendency to purchase product Y” as shown in the lower of FIG. 24. After the confirmation, the system employing the MPC scheme outputs the leaf node of the confirmed route.

The reason that the system employing the MPC scheme evaluates all the classification conditions is because the evaluation results can be presumed on the basis of classification conditions (nodes) that have not been evaluated unless all the classification conditions have been evaluated, and the personal information that is the input can be revealed eventually.

The reason that the evaluation results are presumed is because the evaluated classification conditions can be specified on the basis of the total computation time. For example, it is assumed that the computation times required to evaluate the classification conditions of “B>2”, “A>1”, and “A>2” of the classification tree shown in FIG. 24 is one second, two seconds, and three seconds, respectively.

If the total computation time is three seconds, it is presumed that the prediction process has been completed with the evaluation of the classification conditions of “B>2” and “A>1”, and that the leaf node has been either of “unclear” or “tend to purchase product X”. If the total computation time is four seconds, it is presumed that the prediction process has been completed with the evaluation of the classification conditions of “B>2” and “A>2”, and that the leaf node has been either of “tendency to purchase product Y” or “tendency to purchase product X”.

As described above, if only some of the classification conditions are evaluated, the content of the computation process can leak to the outside. Thus, to perform a prediction process using a classification tree, the system employing the MPC scheme is required to evaluate all the classification conditions.

However, the system employing the MPC scheme requires a larger amount of computation and communication than a normal system does. In order to evaluate all the classification conditions of a classification tree, the time required to perform the secret computation process becomes longer. PTLs 1 to 5 and NPLs 2 to 4 do not disclose the solution of the problem that the secret computation process is delayed by evaluating all the classification conditions of a classification tree.

[Purpose of Invention]

The present invention is to provide a classification tree generation method, a classification tree generation device, and a classification tree generation program that solve the above problem and that can reduce the amount of computation in a prediction process using a classification tree in a system employing an MPC scheme.

### Solution to Problem

A classification tree generation method according to the present invention is a classification tree generation method to be performed by a classification tree generation device that selects, from a plurality of classification condition candidates, a new classification condition to be added to a classification tree, which is a prediction model expressed in a tree structure formed from one or more nodes representing classification conditions, the method including computing information gain relating to the classification condition candidate, computing, as a cost relating to the classification condition candidate, a value representing the magnitude of the smallest difference among differences between the classification condition candidate and each of the classification conditions included in the classification tree, and selecting, as the new classification condition, the classification condition candidate from among the plurality of classification condition candidates that has the largest value among values obtained by subtracting the computed cost from the computed information gain.

A classification tree generation method according to the present invention includes generating all possible classification tree candidates to be generated on the basis of a plurality of classification condition candidates, each classification tree candidate being a prediction model expressed in a tree structure formed from a plurality of nodes representing classification condition candidates, computing, for all the nodes constituting each generated classification tree candidate, a sum of information gain relating to the classification condition candidate included in the generated classification tree candidate, computing, for all the nodes constituting each generated classification tree candidate, a sum of cost relating to the classification condition candidate which is value according to cost of a computation process using the classification condition candidate as input in a prediction process using the generated classification tree candidate, and selecting a classification tree candidate from among the plurality of classification tree candidates that has the largest value among values obtained by subtracting the computed sum of cost from the computed sum of information gain.

A classification tree generation device according to the present invention is a classification tree generation device that selects, from a plurality of classification condition candidates, a new classification condition to be added to a classification tree, which is a prediction model expressed in a tree structure formed from one or more nodes representing classification conditions, the device including a first computation unit that computes information gain relating to the classification condition candidate, a second computation unit that computes, as a cost relating to the classification condition candidate, a value representing the magnitude of the smallest difference among differences between the classification condition candidate and each of the classification conditions included in the classification tree, and a selection unit that selects, as the new classification condition, the classification condition candidate from among the plurality of classification condition candidates that has the largest value among values obtained by subtracting the computed cost from the computed information gain.

A classification tree generation device according to the present invention includes a generation unit that generates all possible classification tree candidates to be generated on the basis of a plurality of classification condition candidates, each classification tree candidate being a prediction model expressed in a tree structure formed from a plurality of nodes representing classification condition candidates, a first computation unit that computes, for all the nodes constituting each generated classification tree candidate, a sum of information gain relating to the classification condition candidate included in the generated classification tree candidate, a second computation unit that computes, for all the nodes constituting each generated classification tree candidate, a sum of cost relating to the classification condition candidate which is value according to cost of a computation process using the classification condition candidate as input in a prediction process using the generated classification tree candidate, and a selection unit that selects a classification tree candidate from among the plurality of classification tree candidates that has the largest value among values obtained by subtracting the computed sum of cost from the computed sum of information gain.

A classification tree generation program according to the present invention causes a computer to execute a first computation process for computing, when a new classification condition to be added to a classification tree, which is a prediction model expressed in a tree structure formed from one or more nodes representing classification conditions is selected from a plurality of classification condition candidates, information gain relating to the classification condition candidate, a second computation process for computing, as a cost relating to the classification condition candidate, a value representing the magnitude of the smallest difference among differences between the classification condition candidate and each of the classification conditions included in the classification tree, and a selection process for selecting, as the new classification condition, the classification condition candidate from among the plurality of classification condition candidates that has the largest value among values obtained by subtracting the computed cost from the computed information gain.

A classification tree generation program according to the present invention causes a computer to execute a generation process for generating all possible classification tree candidates to be generated on the basis of a plurality of classification condition candidates, each classification tree candidate being a prediction model expressed in a tree structure formed from a plurality of nodes representing classification condition candidates, a first computation process for computing, for all the nodes constituting each generated classification tree candidate, a sum of information gain relating to the classification condition candidate included in the generated classification tree candidate, a second computation process for computing, for all the nodes constituting each generated classification tree candidate, a sum of cost relating to the classification condition candidate which is value according to cost of a computation process using the classification condition candidate as input in a prediction process using the generated classification tree candidate, and a selection process for selecting a classification tree candidate from among the plurality of classification tree candidates that has the largest value among values obtained by subtracting the computed sum of cost from the computed sum of information gain.

### Advantageous Effects of Invention

According to the present invention, it is possible to reduce the amount of computation in a prediction process using a classification tree in a system employing an MPC scheme.

### BRIEF DESCRIPTION OF DRAWINGS

FIG. 1 is a block diagram showing a configuration example of a classification tree generation device in a first exemplary embodiment of the present invention.

FIG. 2 is an explanatory diagram showing examples of a variable, a splitting point, and a splitting candidate of a generation target classification tree.

FIG. 3 is an explanatory diagram showing other examples of a variable, a splitting point, and a splitting candidate of the generation target classification tree.

FIG. 4 is an explanatory diagram showing an example of a splitting process of a classification tree generation device 100.

FIG. 5 is an explanatory diagram showing another example of the splitting process of the classification tree generation device 100.

FIG. 6 is an explanatory diagram showing another example of the splitting process of the classification tree generation device 100 and an example of a generated classification tree.

FIG. 7 is an explanatory diagram showing an example in which a Score computation unit 120 changes classification conditions.

FIG. 8 is an explanatory diagram showing a hardware configuration example of the classification tree generation device according to the present invention.

FIG. 9 is an explanatory diagram showing a configuration example of a classification tree generation device in a second exemplary embodiment of the present invention.

FIG. 10 is a flowchart showing an operation in a classification tree generation process of a classification tree generation device 200 in the second exemplary embodiment.

FIG. 11 is a block diagram showing an outline of the classification tree generation device according to the present invention.

FIG. 12 is a block diagram showing another outline of the classification tree generation device according to the present invention.

FIG. 13 is an explanatory diagram showing variables of a generation target classification tree.

FIG. 14 is a block diagram showing a configuration example of a general classification tree generation device.

FIG. 15 is a flowchart showing an operation in a classification tree generation process of a classification tree generation device 900.

FIG. 16 is an explanatory diagram showing an example of a splitting process of the classification tree generation device 900.

FIG. 17 is an explanatory diagram showing another example of the splitting process of the classification tree generation device 900.

FIG. 18 is an explanatory diagram showing another example of the splitting process of the classification tree generation device 900.

FIG. 19 is an explanatory diagram showing another example of the splitting process of the classification tree generation device 900.

FIG. 20 is an explanatory diagram showing another example of the splitting process of the classification tree generation device 900.

FIG. 21 is an explanatory diagram showing an example of a classification tree.

FIG. 22 is an explanatory diagram showing an example of a secret computation technique.

FIG. 23 is an explanatory diagram showing another example of the secret computation technique.

FIG. 24 is an explanatory diagram showing an example of a prediction process using a classification tree in a system employing an MPC scheme.

### DESCRIPTION OF EMBODIMENTS

### First Exemplary Embodiment

[Description of Configuration]

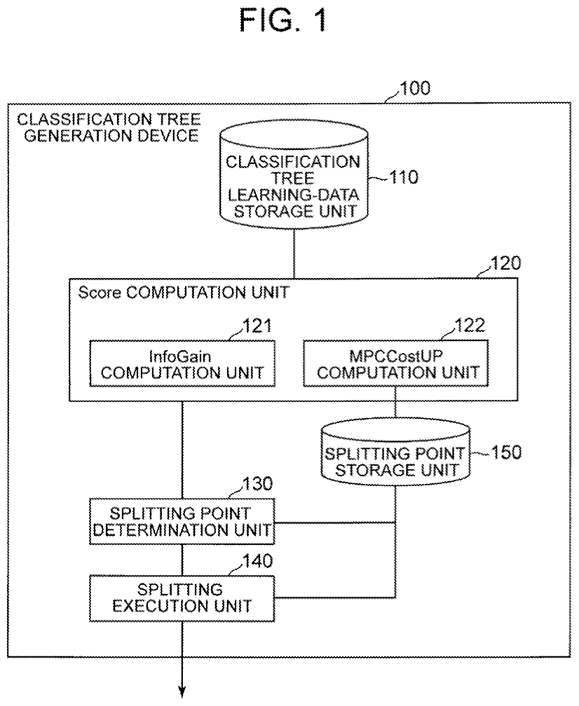

Hereinafter, an exemplary embodiment of the present invention will be described with reference to the drawings. FIG. 1 is a block diagram showing a configuration example of a classification tree generation device in a first exemplary embodiment of the present invention.

A classification tree generation device 100 shown in FIG. 1 includes a classification tree learning-data storage unit 110, a Score computation unit 120, a splitting point determination unit 130, a splitting execution unit 140, and a splitting point storage unit 150. In addition, the Score computation unit 120 includes an InfoGain computation unit 121 and an MPCCostUP computation unit 122.

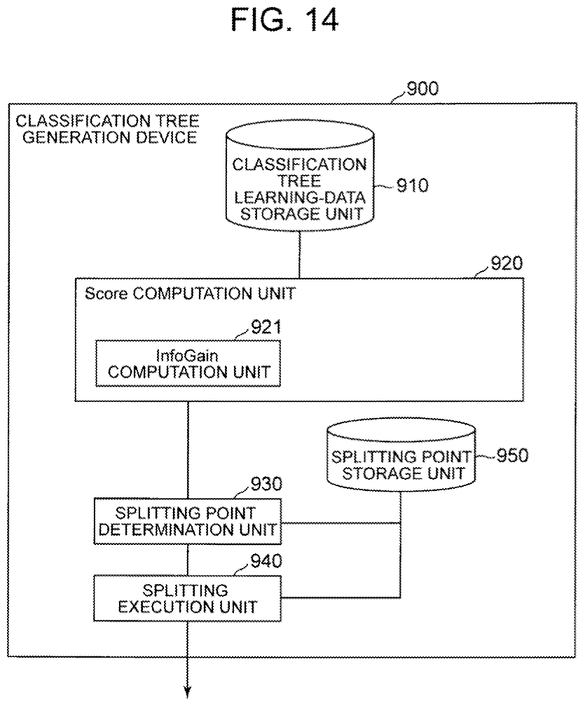

Unlike the classification tree generation device 900 shown in FIG. 14, the classification tree generation device 100 in the present exemplary embodiment includes the MPCCostUP computation unit 122. The configuration of the classification tree generation device 100 other than the MPCCostUP computation unit 122 is similar to the classification tree generation device 900.

When a classification tree is generated, the Score computation unit 120 in the present exemplary embodiment computes Score including not only InformationGain but also MPCCostUP, which is a cost relating to MPC. The MPCCostUP reflects the amount of computation, communication, memory usage, and the like relating to the MPC.

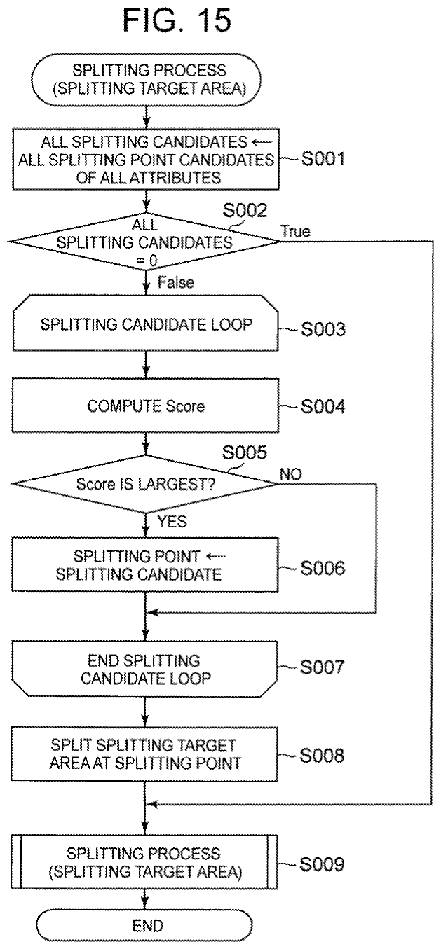

In the process shown in FIG. 15, it is assumed to be “Score=InformationGain”, but the Score in the present exemplary embodiment is computed as follows.

Score=α×InformationGain−β×MPCCostUP Expression (4)

In Expression (4), α and β are independent variables. The method for computing InformationGain is similar to the method described above.

In the following, the method for computing MPCCostUP will be described. The classification condition MPCCostUP is a value corresponding to the cost of a computation process using the classification condition as input in a prediction process using the generated classification tree.

For example, if a splitting candidate is the same as the splitting point stored in the splitting point storage unit 150, the MPCCostUP computation unit 122 computes “MPCCostUP=0”.

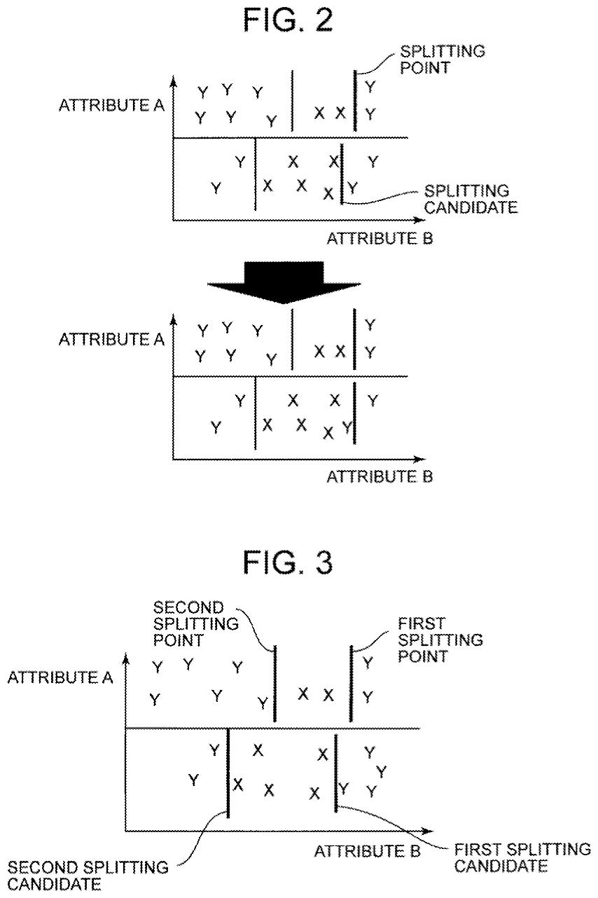

The reason for computing “MPCCostUP=0” when a splitting candidate is the same as a splitting point stored in the splitting point storage unit 150 is described with reference to FIG. 2. FIG. 2 is an explanatory diagram showing examples of a variable, a splitting point, and a splitting candidate of a generation target classification tree.

The splitting candidate and the splitting point shown in the upper of FIG. 2 are positioned close to each other on the attribute B axis. That is, since the corresponding classification conditions are similar to each other, it is considered that the classification accuracy is not significantly reduced if the splitting candidate is matched with the splitting point.

The splitting candidate and the splitting point shown in the lower of FIG. 2 are at the same position on the attribute B axis. If the corresponding classification conditions are the same as shown in the lower of FIG. 2, the classification accuracy is reduced, but the amount of computation in the prediction process is reduced.

If the classification accuracy is not significantly reduced, the amount of computation in the prediction process using a classification tree in a system employing the MPC scheme is further reduced when the splitting candidate closer to the splitting point is matched with the splitting point. The reason is that, in the case of the example shown in the lower of FIG. 2, the system employing the MPC scheme can reuse the computation result of the evaluation of the classification condition corresponding to the splitting point to evaluate the classification condition corresponding to the splitting candidate.

FIG. 3 is an explanatory diagram showing other examples of a variable, a splitting point, and a splitting candidate of the generation target classification tree. For example, if the first splitting candidate is matched with the first splitting point, it is considered that the influence on the classification accuracy is small. However, if the second splitting candidate is matched with the second splitting point, it is considered that the classification accuracy is reduced too much. As described above, adjusting a splitting candidate needs to consider the balance between the amount of computation and the classification accuracy.

As described above, since the splitting point at which the splitting has been performed is stored in the splitting point storage unit 150, the MPCCostUP computation unit 122 computes “MPCCostUP=0” if a splitting candidate is the same as the splitting point stored in the splitting point storage unit 150.

If a splitting candidate is different from the splitting point stored in the splitting point storage unit 150, the MPCCostUP computation unit 122 computes the MPCCostUP as a value according to the type of each classification condition.

For example, the MPCCostUP computation unit 122 may compute the MPCCostUP according to an attribute. For example, when an attribute p is an integer and when an attribute q is a floating point, the MPCCostUP computation unit 122 computes the MPCCostUP of the splitting candidates corresponding to the classification conditions “p>∘” and “q>∘” as “1” and “2”, respectively. Alternatively, when the attribute is a categorical value or range, the MPCCostUP is computed as another value other than “1” and “2”. Note that, ∘ represents an arbitrary value.

Alternatively, the MPCCostUP computation unit 122 may compute the MPCCostUP according to an operator. For example, the MPCCostUP computation unit 122 may compute the MPCCostUP of the splitting candidates corresponding to the classification conditions “0=0” and “o>∘” as “0.5” and “1”, respectively.

Alternatively, the MPCCostUP computation unit 122 may compute the MPCCostUP according to the complexity of computation. For example, the MPCCostUP computation unit 122 may compute the MPCCostUP of the splitting candidates corresponding to the classification conditions “A+B>∘”, “A×B>∘”, and “(A+B)×C>∘” as “2”, “5”, and “10”, respectively by reflecting the load of multiplication.

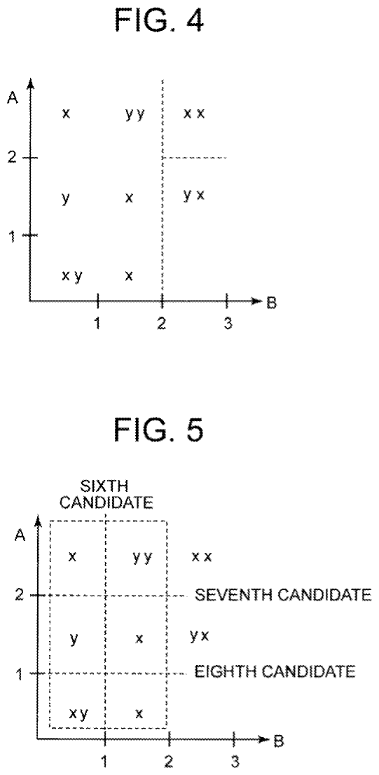

In the following, an example of a classification tree to be generated by the classification tree generation device 100 in the present exemplary embodiment will be described with reference to FIGS. 4 to 6. FIG. 4 is an explanatory diagram showing an example of a splitting process of the classification tree generation device 100.

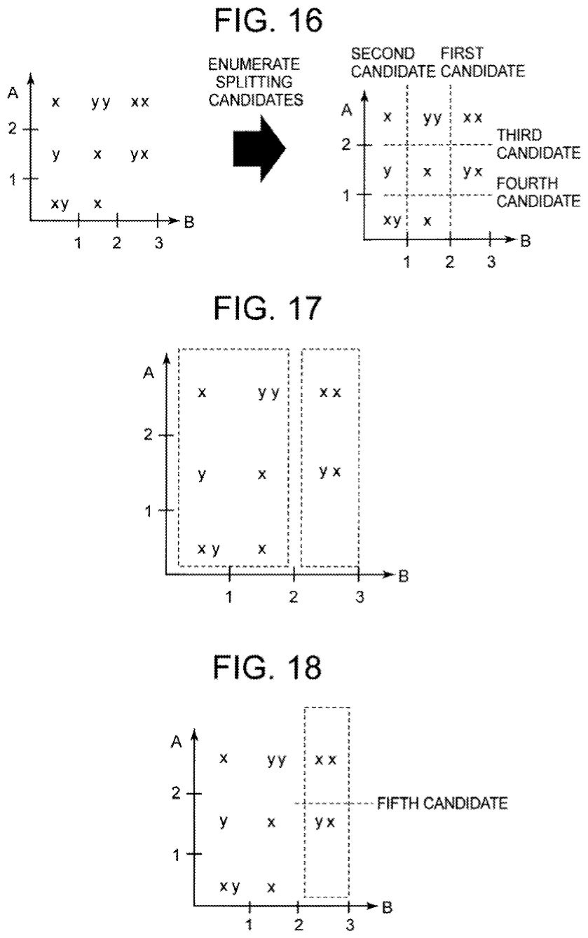

FIG. 4 shows a splitting target area after splitting is performed twice. The splitting execution unit 140 performs the first splitting with “B=2”. The splitting candidates are the first to fourth candidates shown in the right of FIG. 16, but since the MPCCostUP of all the splitting candidates is the same value, and the splitting point determination unit 130 determines the first candidate as the splitting point according to the InformationGain. After the splitting is performed, the splitting point “B=2” is stored in the splitting point storage unit 150.

The splitting execution unit 140 performs the second splitting with “A=2” in the right splitting target area. Since the splitting candidate is only the fifth candidate shown in FIG. 18, the splitting point determination unit 130 simply determines the fifth candidate as the splitting point. After the splitting is performed, the splitting point storage unit 150 stores the splitting point “B=2” and the splitting point “A=2”.

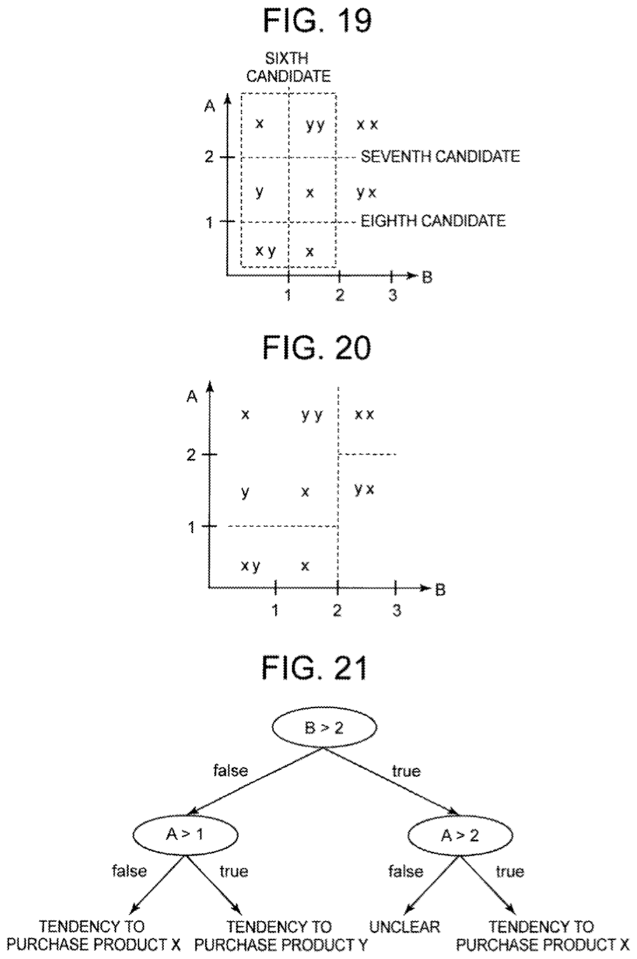

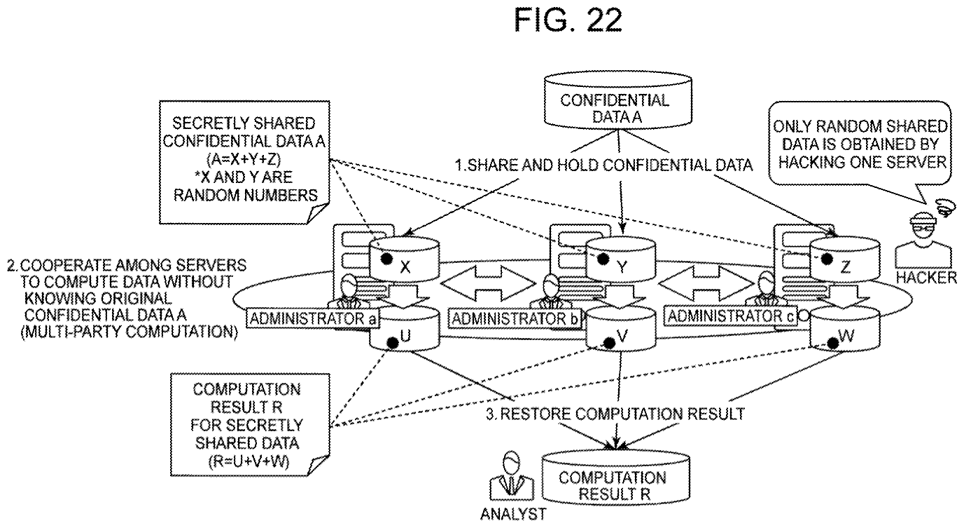

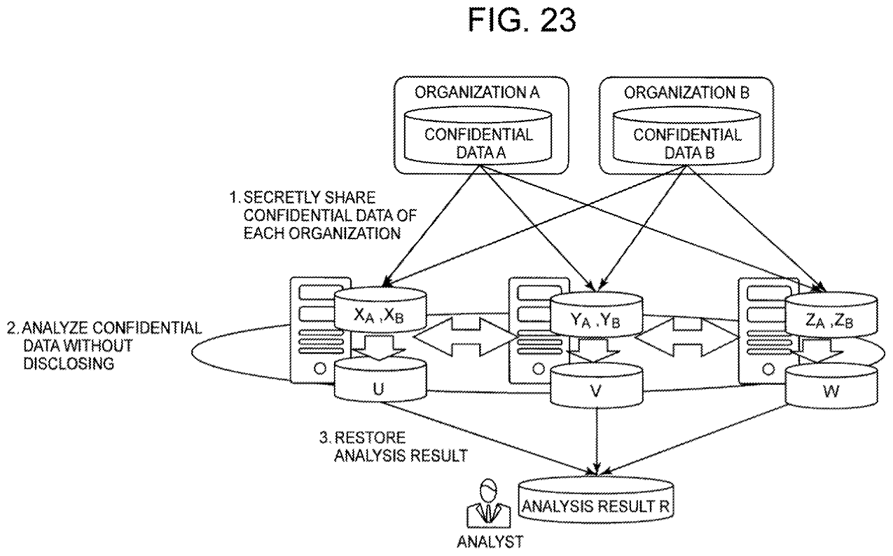

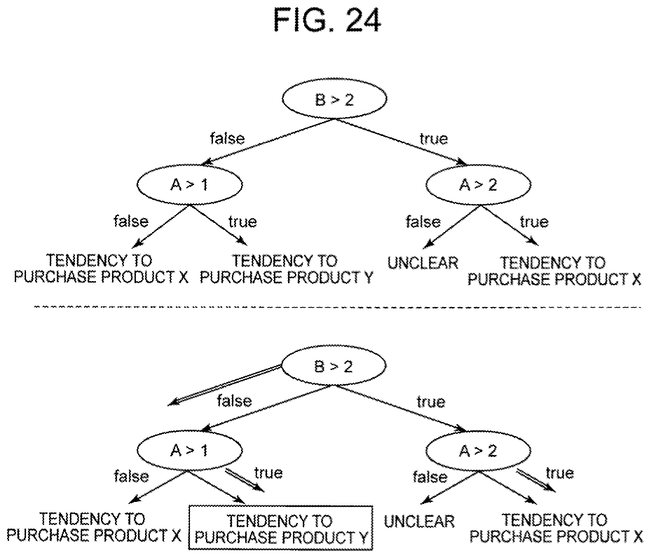

FIG. 5 is an explanatory diagram showing another example of the splitting process of the classification tree generation device 100. The classification tree generation device 100 performs the second splitting in the left splitting target area. Similarly to the example shown in FIG. 19, the splitting candidates in the left area are the sixth candidate, the seventh candidate, and the eighth candidate.

The Score computation unit 120 computes the Score of each candidate according to Expression (4) with α=0.99 and β=0.01. The InfoGain computation unit 121 computes the InformationGain of the sixth candidate, the seventh candidate, and the eighth candidate as 0.0, 0.014, and 0.014, respectively.

The MPCCostUP computation unit 122 further computes the MPCCostUP of the sixth candidate, the seventh candidate, and the eighth candidate as 1, 0, and 1, respectively. The reason that the MPCCostUP of the seventh candidate is 0 is because the same splitting point “A=2” as the seventh candidate is stored in the splitting point storage unit 150.

Since the Score of the seventh candidate is the largest among the computed score of the candidates, the splitting point determination unit 130 determines the seventh candidate as the splitting point. Then, the splitting execution unit 140 splits the left splitting target area at the seventh candidate.

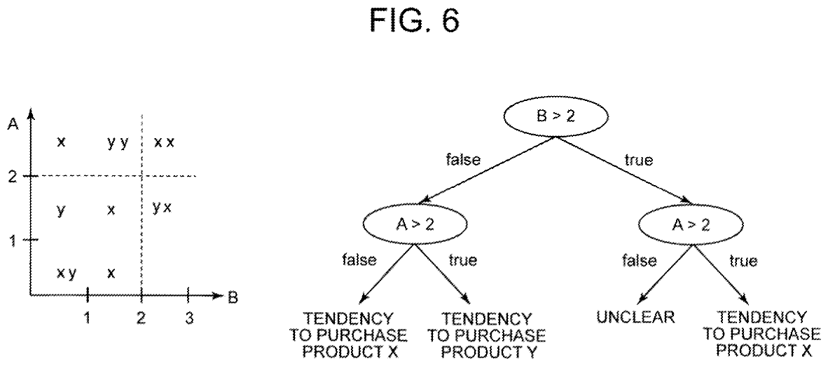

FIG. 6 is an explanatory diagram showing another example of the splitting process of the classification tree generation device 100 and an example of the generated classification tree. The left of FIG. 6 shows the splitting target area after being split at the seventh candidate.

The right of FIG. 6 is the classification tree generated on the basis of the splitting target area shown in the left of FIG. 6. The classification tree shown in the right of FIG. 6 has two nodes with the classification condition “A>2”. Thus, for example, when the classification condition of the right node is evaluated, the computation result when the classification condition of the left node is evaluated can be reused, and the amount of computation required for the entire prediction process can be reduced.

As described above, the MPCCostUP computation unit 122 may compute the MPCCostUP as 0 if the same splitting point as the splitting candidate is stored in the splitting point storage unit 150. Alternatively, the MPCCostUP computation unit 122 may compute the value of the MPCCostUP according to the type of a classification condition. For example, the MPCCostUP computation unit 122 may compute the value of the MPCCostUP according to the type of an attribute (an integer, a floating point, a category value) or the type of an operator (magnitude comparison, matching) of the classification condition.

Alternatively, if the classification condition corresponding to the splitting candidate is the same as the classification condition corresponding to the splitting point stored in the splitting point storage unit 150 partway, the MPCCostUP computation unit 122 may compute the cost regarding only the different part as the MPCCostUP.

For example, when the splitting point storage unit 150 stores the splitting point corresponding to the classification condition “(A+B)×A>1”, and when the classification condition corresponding to the splitting candidate is “(A+B)×B>2”, the computation result of “(A+B)”, which is the common part, can be reused.

Thus, the MPCCostUP computation unit 122 may compute the computational cost for “∘×B>2” as the MPCCostUP. That is, the MPCCostUP is a value indicating the magnitude of the difference between a classification condition candidate to be added to the classification tree and the classification condition included in the classification tree. In Expression (4), the value indicating the magnitude of the minimum difference among the differences between the classification condition candidate and each classification condition included in the classification tree is used as the MPCCostUP.

Alternatively, the MPCCostUP computation unit 122 may compute the MPCCostUP according to the depth of the AND circuit in the logic circuit representing the system employing the MPC scheme for evaluating the classification conditions. The amounts of computation and communication relating to the MPC depend on the depth of the AND circuit in the logic circuit representing the system employing the MPC scheme.

In the present exemplary embodiment, it is important to properly balance the InformationGain and the MPCCostUP in Score computation. For example, the computational cost relating to the MPC depends on the amount of computation in the entire prediction process using the classification tree, that is, the number of classification conditions of the classification tree. In order to achieve a balance, it is considered that the influence of MPCCostUP is increased by making 13 larger than a as the number of classification conditions of the classification tree increases.

In addition, if an execution environment for the prediction process is an environment where a wide communication bandwidth is prepared and a high-speed central processing unit (CPU) is installed, the influence of the MPCCostUP may not be considered so much. Thus, it is considered that the influence of the MPCCostUP is reduced by making α larger than β for balancing.

[Description of Operation]

The operation in the splitting process of the classification tree generation device 100 in the present exemplary embodiment is similar to the operation shown in FIG. 15. In the present exemplary embodiment, in step S004, the Score computation unit 120 computes the Score of a splitting candidate on the basis of the InformationGain and the MPCCostUP.

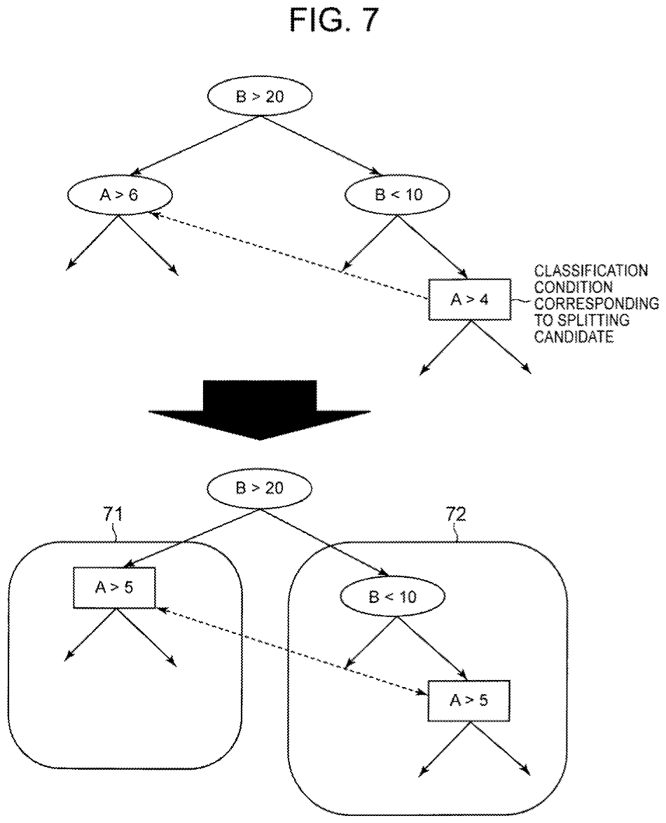

If the classification conditions of the other nodes corresponding to the splitting points stored in the splitting point storage unit 150 are similar to the classification conditions corresponding to the splitting candidates, the Score computation unit 120 may change the conditions as follows. FIG. 7 is an explanatory diagram showing an example in which the Score computation unit 120 changes classification conditions.

When computing the Score, the MPCCostUP computation unit 122 of the Score computation unit 120 refers to the splitting points stored in the splitting point storage unit 150. At the time of the reference, the Score computation unit 120 may change classification conditions to the respective corresponding conditions each including intermediate value between the value of the referred splitting point and the value of the splitting candidate.

The upper of FIG. 7 shows the classification tree before the classification conditions are changed. The classification condition “A>4” corresponding to the splitting candidate and the classification condition “A>6” shown in the upper of FIG. 7 are similar. With respect to the classification tree shown in the upper of FIG. 7, the Score computation unit 120 changes both conditions to “A>5” including the intermediate value of 5.

The lower of FIG. 7 shows the classification tree after the classification conditions are changed. After the classification conditions are changed, the splitting process in the area corresponding to an area 71 shown in the lower of FIG. 7 is required to be performed again at a new splitting point. Note that, the change of the classification conditions shown in FIG. 7 is feasible only under classification conditions that do not affect an area 72 if the splitting is performed again in the area corresponding to the area 71.

Alternatively, a threshold for changing the classification conditions shown in FIG. 7 may be determined in association with the value of the weight a and the value of the weight 13 of the Score computation. The threshold is determined according to the degree of reduction in the amount of required computation. When the classification conditions shown in FIG. 7 are changed, the splitting candidates having the same classification conditions are forcibly generated although the number of identical classification conditions is low, and the amount of computation in the prediction process is reliably reduced.

[Description of Effects]

The classification tree generation device 100 in the present exemplary embodiment can reduce the amount of computation in the prediction process using the classification tree in the system employing the MPC scheme. The reason is that the Score computation unit 120 computes Score so that the Score of the splitting candidate corresponding to the condition that matches the classification condition already used in the classification tree or the condition that is similar to the classification condition is increased, and that the classification tree to be generated easily includes the same classification conditions or similar classification conditions.

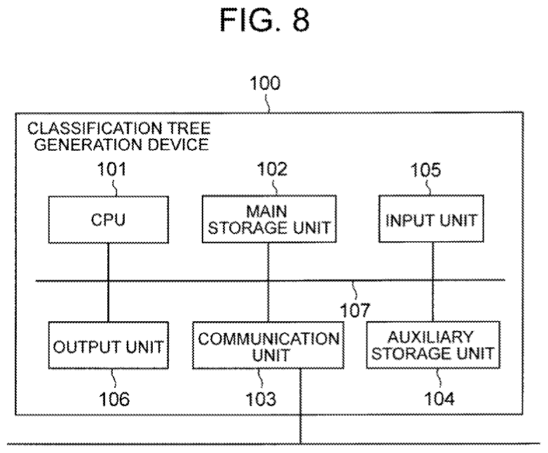

In the following, a specific example of a hardware configuration of the classification tree generation device 100 in the first exemplary embodiment will be described. FIG. 8 is an explanatory diagram showing a hardware configuration example of the classification tree generation device according to the present invention.

The classification tree generation device 100 shown in FIG. 8 includes a CPU 101, a main storage unit 102, a communication unit 103, and an auxiliary storage unit 104. The classification tree generation device 100 may further includes an input unit 105 for the user to operate and an output unit 106 for presenting a processing result or the progress of the processing content to the user.

The main storage unit 102 is used as a work region of data and a temporary save region of data. The main storage unit 102 is, for example, a random access memory (RAM).

The communication unit 103 has a function of inputting and outputting data to and from peripheral devices via a wired network or a wireless network (information communication network).

The auxiliary storage unit 104 is a non-transitory tangible storage medium. The non-transitory tangible storage medium is, for example, a magnetic disk, a magneto-optical disk, a compact disk read only memory (CD-ROM), a digital versatile disk read only memory (DVD-ROM), or a semiconductor memory.

The input unit 105 has a function of inputting data and processing instructions. The input unit 105 is an input device, such as a keyboard or a mouse.

The output unit 106 has a function of outputting data. The output unit 106 is, for example, a display device, such as a liquid crystal display device, or a printing device, such as a printer.

In addition, as shown in FIG. 8, the constituent elements of the classification tree generation device 100 are connected to a system bus 107.

The auxiliary storage unit 104 stores, for example, programs for implementing the InfoGain computation unit 121, the MPCCostUP computation unit 122, the splitting point determination unit 130, and the splitting execution unit 140 shown in FIG. 1.

In addition, the classification tree learning-data storage unit 110 and the splitting point storage unit 150 may be implemented by the RAM that is the main storage unit 102.

### Second Exemplary Embodiment

[Description of Configuration]

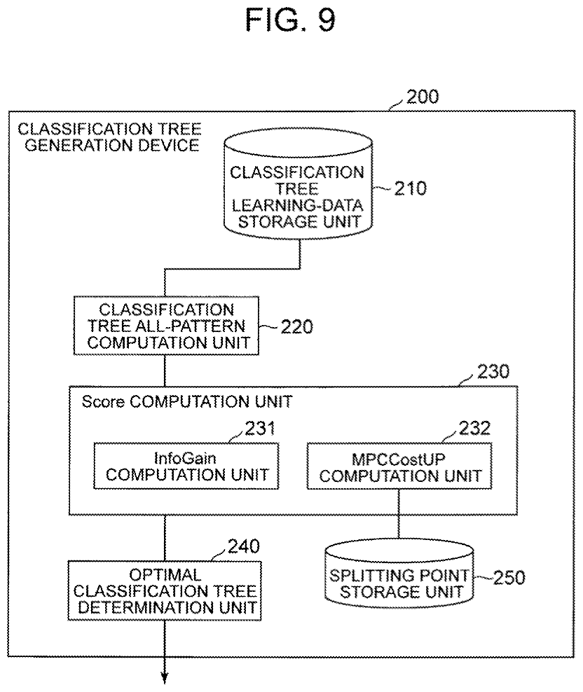

Next, a second exemplary embodiment of the present invention will be described with reference to the drawings. FIG. 9 is an explanatory diagram showing a configuration example of a classification tree generation device in a second exemplary embodiment of the present invention.

A classification tree generation device 200 shown in FIG. 9 includes a classification tree learning-data storage unit 210, a classification tree all-pattern computation unit 220, a Score computation unit 230, an optimal classification tree determination unit 240, and a splitting point storage unit 250. In addition, the Score computation unit 230 includes an InfoGain computation unit 231 and an MPCCostUP computation unit 232.

The respective functions of the classification tree learning-data storage unit 210, the InfoGain computation unit 231, the MPCCostUP computation unit 232, and the splitting point storage unit 250 are similar to the respective functions of the classification tree learning-data storage unit 110, the InfoGain computation unit 121, the MPCCostUP computation unit 122, and splitting point storage unit 150 in the first exemplary embodiment.

The classification tree generation device 100 in the first exemplary embodiment considers InformationGain and MPCCostUP of each splitting candidate, determines the splitting candidate having the largest Score as the splitting point, and performs splitting at the splitting point. That is, the classification tree generation device 100 performs splitting (splitting in a greedy manner) every time a splitting point is determined.

The classification tree generation process in which splitting is performed in a greedy manner has an advantage that the amount of computation required for generating the classification tree is small, but has a disadvantage that an optimal solution is not always obtained. The reason is that not all the classification tree candidates can be considered.

The classification tree all-pattern computation unit 220 of the classification tree generation device 200 in the present exemplary embodiment generates all tree structures that can be considered as classification trees in the beginning instead of splitting the splitting target area in a greedy manner. Then, the Score computation unit 230 computes, for all the generated tree structures, the InformationGain of the entire tree and the MPCCost of the entire tree.

Then, the Score computation unit 230 computes the Score for all the tree structures on the basis of the computed InformationGain of the entire tree and the computed MPCCost of the entire tree. Then, the optimal classification tree determination unit 240 selects the optimal classification tree on the basis of the computed Score. By selecting the classification tree with the above method, the classification tree generation device 200 can more reliably generate the classification tree, which is the optimal solution.

[Description of Operation]

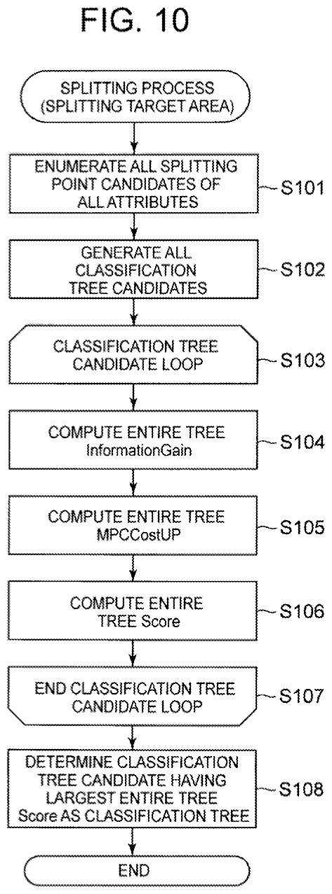

In the following, the operation in order for the classification tree generation device 200 in the present exemplary embodiment to generate the classification tree will be described with reference to FIG. 10. FIG. 10 is a flowchart showing the operation in a classification tree generation process of the classification tree generation device 200 in the second exemplary embodiment.

The input for the splitting process shown in FIG. 10 is the splitting target area. First, the classification tree all-pattern computation unit 220 enumerates splitting point candidates relating to the explanatory variables in the splitting target area stored in the classification tree learning-data storage unit 210 as splitting candidates (step S101). That is, the classification tree all-pattern computation unit 220 enumerates all the splitting candidates for the entire area.

Then, the classification tree all-pattern computation unit 220 generates all the classification tree candidates by repeatedly performing splitting so that the area is split at all the splitting candidates (step S102).

Then, the Score computation unit 230 extracts, from all the classification tree candidates, one classification tree candidate whose entire tree Score has not been computed. That is, the Score computation unit 230 enters a classification tree candidate loop (step S103).

With respect to the extracted classification tree candidate, the InfoGain computation unit 231 of the Score computation unit 230 computes the entire tree InformationGain by summing the InformationGain of the classification conditions for the nodes of the classification tree candidate (step S104).

Then, the MPCCostUP computation unit 232 of the Score computation unit 230 computes, with respect to the extracted classification tree candidate, the entire tree MPCCostUP by summing the MPCCostUP of the classification conditions for the nodes of the classification tree candidate (step S105). If the nodes are different but the classification conditions are the same, the MPCCostUP for only one node is added to the entire tree MPCCostUP.

Next, the Score computation unit 230 computes the entire tree Score as follows (step S106).

Entire tree Score=α×entire tree InformationGain−β×entire tree MPCCostUP Expression (5)

The processes of steps S104 to S106 are repeated while there is a classification tree candidate whose entire tree Score has not been computed among all the classification tree candidates. When the entire tree Scores of all the classification tree candidates are computed, the Score computation unit 230 exits from the classification tree candidate loop (step S107).

Then, the optimal classification tree determination unit 240 determines the classification tree candidate having the largest entire tree Score among all the classification tree candidates as the classification tree (step S108). After determining the classification tree, the classification tree generation device 200 terminates the classification tree generation process.

[Description of Effects]

The classification tree generation device 200 in the present exemplary embodiment can generate the classification tree, which is the optimal solution, more reliably than the classification tree generation device 100 in the first exemplary embodiment does. The reason is that the classification tree all-pattern computation unit 220 generates all possible classification tree candidates to be generated in the beginning, and the Score computation unit 230 computes the entire tree Score of each classification tree candidate, which prevents classification tree candidates from not being considered.

The hardware configuration of the classification tree generation device 200 may be similar to the hardware configuration shown in FIG. 8.

Alternatively, the classification tree generation device 100 and the classification tree generation device 200 may be implemented by hardware. For example, the classification tree generation device 100 and the classification tree generation device 200 may have a circuit including a hardware component, such as large scale integration (LSI) incorporating a program for implementing the functions shown in FIG. 1 or the functions shown in FIG. 9.

Alternatively, the classification tree generation device 100 and the classification tree generation device 200 may be implemented by software by the CPU 101 shown in FIG. 8 executing programs providing the functions of the constituent elements shown in FIG. 1 or the functions of the constituent elements shown in FIG. 9.

In the case of being implemented by software, the CPU 101 loads the program stored in the auxiliary storage unit 104 in the main storage unit 102 and executes the program to control the operation of the classification tree generation device 100 or the classification tree generation device 200, whereby the functions are implemented by software.

In addition, a part of or all of the constituent elements are implemented by a general purpose circuitry, a dedicated circuitry, a processor, or the like, or a combination thereof. These may be constituted by a single chip, or by a plurality of chips connected via a bus. A part of or all of the constituent elements may be implemented by a combination of the above circuitry or the like and a program.

In the case in which a part of or all of the constituent elements are implemented by a plurality of information process devices, circuitries, or the like, the information process devices, circuitries, or the like may be arranged in a concentrated manner, or dispersedly. For example, the information process devices, circuitries, or the like may be implemented as a form in which each component is connected via a communication network, such as a client-and-server system or a cloud computing system.

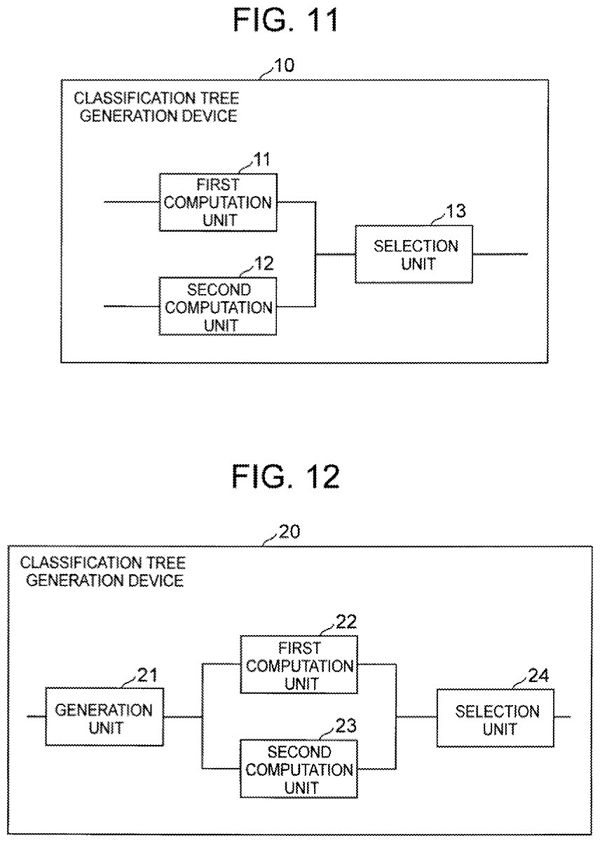

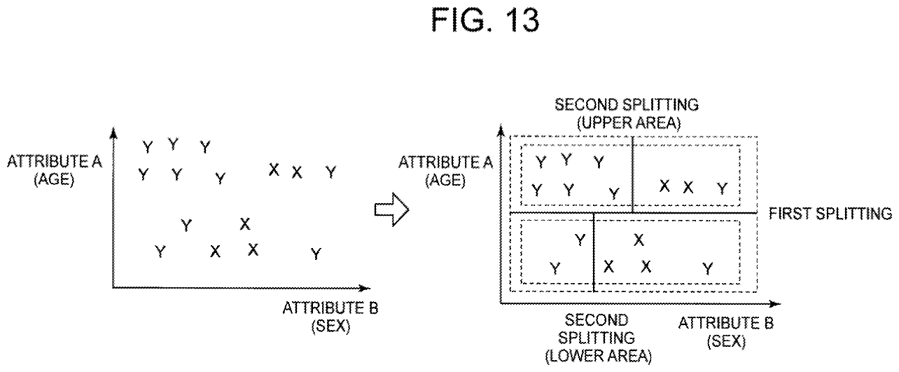

Next, an outline of the present invention will be described. FIG. 11 is a block diagram showing an outline of the classification tree generation device according to the present invention. A classification tree generation device 10 according to the present invention is a classification tree generation device that selects, from a plurality of classification condition candidates, a new classification condition to be added to a classification tree, which is a prediction model expressed in a tree structure formed from one or more nodes representing classification conditions, the device including a first computation unit 11 (for example, the InfoGain computation unit 121) that computes information gain relating to the classification condition candidate, a second computation unit 12 (for example, the MPCCostUP computation unit 122) that computes, as a cost relating to the classification condition candidate, a value representing the magnitude of the smallest difference among differences between the classification condition candidate and each of the classification conditions included in the classification tree, and a selection unit 13 (for example, the splitting point determination unit 130) that selects, as the new classification condition, the classification condition candidate from among the plurality of classification condition candidates that has the largest value among values obtained by subtracting the computed cost from the computed information gain.

With such a configuration, the classification tree generation device can reduce the amount of computation in the prediction process using the classification tree in the system employing the MPC scheme.

In addition, the second computation unit 12 may compute the cost relating to a same classification condition candidate as the classification condition included in the classification tree to be 0.

With such a configuration, the classification tree generation device can reduce the amount of computation in the prediction process using the classification tree in the system employing the MPC scheme.

In addition, the second computation unit 12 may compute, according to content of classification condition candidate (for example, the attribute, the operator, and the computation of the attribute included in the classification condition), the cost relating to the classification condition candidate.

With such a configuration, the classification tree generation device can reflect, in cost, the amount of computation in the prediction process using the classification tree in the system employing the MPC scheme.

In addition, the second computation unit 12 may generate a logic circuit representing a system that performs a prediction process using the classification tree and compute the cost relating to the classification condition candidate according to an AND circuit included in the generated logic circuit.

With such a configuration, the classification tree generation device can more accurately reflect, in cost, the amount of computation in the prediction process using the classification tree in the system employing the MPC scheme.

In addition, the second computation unit 12 may change the weight of the computed cost to be subtracted from information gain computed according to the depth of the classification tree or the number of the classification conditions included in the classification tree.

With such a configuration, the classification tree generation device can balance between the amount of computation in the whole prediction process using the classification tree in the system employing the MPC scheme and the information gain.

In addition, the second computation unit 12 may change the weight of the computed cost to be subtracted from information gain computed according to the processing capacity (for example, the communication bandwidth or the CPU speed) of the system that performs the prediction process using the classification tree.

With such a configuration, the classification tree generation device can, in cost, reflect the processing capacity of the system employing the MPC scheme.

In addition, the second computation unit 12 may change a classification condition candidate that has the magnitude of the smallest difference less than or equal to a predetermined threshold and a classification condition included in the classification tree to new conditions generated on the basis of the classification condition candidate and the classification condition.

With such a configuration, the classification tree generation device can reduce the amount of computation in the prediction process using the classification tree although the classification tree does not include the same classification condition as the classification condition candidate.

FIG. 12 is a block diagram showing another outline of the classification tree generation device according to the present invention. A classification tree generation device 20 according to the present invention includes a generation unit 21 (for example, the classification tree all-pattern computation unit 220) that generates all possible classification tree candidates to be generated on the basis of a plurality of classification condition candidates, each classification tree candidate being a prediction model expressed in a tree structure formed from a plurality of nodes representing classification condition candidates, a first computation unit 22 (for example, the InfoGain computation unit 231) that computes, for all the nodes constituting each generated classification tree candidate, a sum of information gain relating to the classification condition candidate included in the generated classification tree candidate, a second computation unit 23 (for example, the MPCCostUP computation unit 232) that computes, for all the nodes constituting each generated classification tree candidate, a sum of cost relating to the classification condition candidate which is value according to cost of a computation process using the classification condition candidate as input in a prediction process using the generated classification tree candidate, and a selection unit 24 (for example, the optimal classification tree determination unit 240) that selects a classification tree candidate from among the plurality of classification tree candidates that has the largest value among values obtained by subtracting the computed sum of cost from the computed sum of information gain.

With such a configuration, the classification tree generation device can reduce the amount of computation in the prediction process using the classification tree in the system employing the MPC scheme.

The present invention has been described with reference to the exemplary embodiments and examples, but is not limited to the above exemplary embodiments and examples. Various changes that can be understood by those skilled in the art within the scope of the present invention can be made to the configurations and details of the present invention.

In addition, a part or all of the above exemplary embodiments can also be described as follows, but are not limited to the following.

### (Supplementary Note 1)

A classification tree generation method to be performed by a classification tree generation device configured to select, from a plurality of classification condition candidates, a new classification condition to be added to a classification tree, which is a prediction model expressed in a tree structure formed from one or more nodes representing classification conditions, the method including: computing information gain relating to the classification condition candidate; computing, as a cost relating to the classification condition candidate, a value representing the magnitude of the smallest difference among differences between the classification condition candidate and each of the classification conditions included in the classification tree; and selecting, as the new classification condition, the classification condition candidate from among the plurality of classification condition candidates that has the largest value among values obtained by subtracting the computed cost from the computed information gain.

### (Supplementary Note 2)

The classification tree generation method according to Supplementary note 1 further including computing the cost relating to a same classification condition candidate as the classification condition included in the classification tree to be 0.

### (Supplementary Note 3)

The classification tree generation method according to Supplementary note 1 or 2, further including computing, according to content of classification condition candidate, the cost relating to the classification condition candidate.

### (Supplementary Note 4)

The classification tree generation method according to any one of Supplementary notes 1 to 3, further including: generating a logic circuit representing a system that performs a prediction process using the classification tree; and computing the cost relating to the classification condition candidate according to an AND circuit included in the generated logic circuit.

### (Supplementary Note 5)

The classification tree generation method according to any one of Supplementary notes 1 to 4, further including changing the weight of the computed cost to be subtracted from information gain computed according to the depth of the classification tree or the number of the classification conditions included in the classification tree.

### (Supplementary Note 6)

The classification tree generation method according to any one of Supplementary notes 1 to 5, further including changing the weight of the computed cost to be subtracted from information gain computed according to the processing capacity of the system that performs the prediction process using the classification tree.

### (Supplementary Note 7)

The classification tree generation method according to any one of Supplementary notes 1 to 6, further including changing a classification condition candidate that has the magnitude of the smallest difference less than or equal to a predetermined threshold and a classification condition included in the classification tree to new conditions generated on the basis of the classification condition candidate and the classification condition.

### (Supplementary Note 8)

A classification tree generation method including: generating all possible classification tree candidates to be generated on the basis of a plurality of classification condition candidates, each classification tree candidate being a prediction model expressed in a tree structure formed from a plurality of nodes representing classification condition candidates; computing, for all the nodes constituting each generated classification tree candidate, a sum of information gain relating to the classification condition candidate included in the generated classification tree candidate; computing, for all the nodes constituting each generated classification tree candidate, a sum of cost relating to the classification condition candidate which is value according to cost of a computation process using the classification condition candidate as input in a prediction process using the generated classification tree candidate; and selecting a classification tree candidate from among the plurality of classification tree candidates that has the largest value among values obtained by subtracting the computed sum of cost from the computed sum of information gain.

### (Supplementary Note 9)

A classification tree generation device configured to select, from a plurality of classification condition candidates, a new classification condition to be added to a classification tree, which is a prediction model expressed in a tree structure formed from one or more nodes representing classification conditions, the device including: a first computation unit configured to compute information gain relating to the classification condition candidate; a second computation unit configured to compute, as a cost relating to the classification condition candidate, a value representing the magnitude of the smallest difference among differences between the classification condition candidate and each of the classification conditions included in the classification tree; and a selection unit configured to select, as the new classification condition, the classification condition candidate from among the plurality of classification condition candidates that has the largest value among values obtained by subtracting the computed cost from the computed information gain.

### (Supplementary Note 10)

A classification tree generation device including: a generation unit configured to generate all possible classification tree candidates to be generated on the basis of a plurality of classification condition candidates, each classification tree candidate being a prediction model expressed in a tree structure formed from a plurality of nodes representing classification condition candidates; a first computation unit configured to compute, for all the nodes constituting each generated classification tree candidate, a sum of information gain relating to the classification condition candidate included in the generated classification tree candidate; a second computation unit configured to compute, for all the nodes constituting each generated classification tree candidate, a sum of cost relating to the classification condition candidate which is value according to cost of a computation process using the classification condition candidate as input in a prediction process using the generated classification tree candidate; and a selection unit configured to select a classification tree candidate from among the plurality of classification tree candidates that has the largest value among values obtained by subtracting the computed sum of cost from the computed sum of information gain.

### (Supplementary Note 11)

A classification tree generation program causing a computer to execute: a first computation process for computing, when a new classification condition to be added to a classification tree, which is a prediction model expressed in a tree structure formed from one or more nodes representing classification conditions is selected from a plurality of classification condition candidates, information gain relating to the classification condition candidate; a second computation process for computing, as a cost relating to the classification condition candidate, a value representing the magnitude of the smallest difference among differences between the classification condition candidate and each of the classification conditions included in the classification tree; and a selection process for selecting, as the new classification condition, the classification condition candidate from among the plurality of classification condition candidates that has the largest value among values obtained by subtracting the computed cost from the computed information gain.

### (Supplementary Note 12)

A classification tree generation program causing a computer to execute: a generation process for generating all possible classification tree candidates to be generated on the basis of a plurality of classification condition candidates, each classification tree candidate being a prediction model expressed in a tree structure formed from a plurality of nodes representing classification condition candidates; a first computation process for computing, for all the nodes constituting each generated classification tree candidate, a sum of information gain relating to the classification condition candidate included in the generated classification tree candidate; a second computation process for computing, for all the nodes constituting each generated classification tree candidate, a sum of cost relating to the classification condition candidate which is value according to cost of a computation process using the classification condition candidate as input in a prediction process using the generated classification tree candidate; and a selection process for selecting a classification tree candidate from among the plurality of classification tree candidates that has the largest value among values obtained by subtracting the computed sum of cost from the computed sum of information gain.

### INDUSTRIAL APPLICABILITY

The present invention is preferably applied to the field of a secret computation technology.

### REFERENCE SIGNS LIST

10, 20, 100, 200, 900 Classification tree generation device
11, 22 First computation unit
12, 23 Second computation unit
13, 24 Selection unit
21 Generation unit
101 CPU
102 Main storage unit
103 Communication unit
104 Auxiliary storage unit
105 Input unit
106 Output unit
107 System bus
110, 210, 910 Classification tree learning-data storage unit
220 Classification tree all-pattern computation unit
120, 230, 920 Score computation unit
121, 231, 921 InfoGain computation unit
122, 232 MPCCostUP computation unit
130, 930 Splitting point determination unit
140, 940 Splitting execution unit
240 Optimal classification tree determination unit
150, 250, 950 Splitting point storage unit

1. A computer-implemented classification tree generation method to be performed by a classification tree generation device configured to select, from a plurality of classification condition candidates, a new classification condition to be added to a classification tree, which is a prediction model expressed in a tree structure formed from one or more nodes representing classification conditions, the method comprising:
computing information gain relating to the classification condition candidate, for each of the classification condition candidates respectively;
computing, as a cost relating to the classification condition candidate, a value representing the magnitude of the smallest difference among differences between the classification condition candidate and each of the classification conditions included in the classification tree, for each of the classification condition candidates respectively; and
selecting, as the new classification condition, the classification condition candidate from among the plurality of classification condition candidates that has the largest value among values obtained by subtracting the computed cost from the computed information gain.

2. The computer-implemented classification tree generation method according to claim 1 further comprising
computing the cost relating to a same classification condition candidate as the classification condition included in the classification tree to be 0.

3. The computer-implemented classification tree generation method according to claim 1, further comprising
computing, according to content of classification condition candidate, the cost relating to the classification condition candidate.

4. The computer-implemented classification tree generation method according to claim 1, further comprising:
generating a logic circuit representing a system that performs a prediction process using the classification tree; and
computing the cost relating to the classification condition candidate according to an AND circuit included in the generated logic circuit.

5. The computer-implemented classification tree generation method according to claim 1, further comprising
changing the weight of the computed cost to be subtracted from information gain computed according to the depth of the classification tree or the number of the classification conditions included in the classification tree.

6. The computer-implemented classification tree generation method according to claim 1, further comprising
changing the weight of the computed cost to be subtracted from information gain computed according to the processing capacity of the system that performs the prediction process using the classification tree.

7. The computer-implemented classification tree generation method according to claim 1, further comprising
changing a classification condition candidate that has the magnitude of the smallest difference less than or equal to a predetermined threshold and a classification condition included in the classification tree to new conditions generated on the basis of the classification condition candidate and the classification condition.

8. A computer-implemented classification tree generation method comprising:
generating all possible classification tree candidates to be generated on the basis of a plurality of classification condition candidates, each classification tree candidate being a prediction model expressed in a tree structure formed from a plurality of nodes representing classification condition candidates;
computing, for all the nodes constituting each generated classification tree candidate, a sum of information gain relating to the classification condition candidate included in the generated classification tree candidate;
computing, for all the nodes constituting each generated classification tree candidate, a sum of cost relating to the classification condition candidate which is value according to cost of a computation process using the classification condition candidate as input in a prediction process using the generated classification tree candidate; and
selecting a classification tree candidate from among the plurality of classification tree candidates that has the largest value among values obtained by subtracting the computed sum of cost from the computed sum of information gain.

9. A classification tree generation device configured to select, from a plurality of classification condition candidates, a new classification condition to be added to a classification tree, which is a prediction model expressed in a tree structure formed from one or more nodes representing classification conditions, the device comprising:
a first computation unit configured to compute information gain relating to the classification condition candidate, for each of the classification condition candidates respectively;
a second computation unit configured to compute, as a cost relating to the classification condition candidate, a value representing the magnitude of the smallest difference among differences between the classification condition candidate and each of the classification conditions included in the classification tree, for each of the classification condition candidates respectively; and
a selection unit configured to select, as the new classification condition, the classification condition candidate from among the plurality of classification condition candidates that has the largest value among values obtained by subtracting the computed cost from the computed information gain.

10. A classification tree generation device comprising:
a generation unit configured to generate all possible classification tree candidates to be generated on the basis of a plurality of classification condition candidates, each classification tree candidate being a prediction model expressed in a tree structure formed from a plurality of nodes representing classification condition candidates;
a first computation unit configured to compute, for all the nodes constituting each generated classification tree candidate, a sum of information gain relating to the classification condition candidate included in the generated classification tree candidate;
a second computation unit configured to compute, for all the nodes constituting each generated classification tree candidate, a sum of cost relating to the classification condition candidate which is value according to cost of a computation process using the classification condition candidate as input in a prediction process using the generated classification tree candidate; and
a selection unit configured to select a classification tree candidate from among the plurality of classification tree candidates that has the largest value among values obtained by subtracting the computed sum of cost from the computed sum of information gain.

11. A non-transitory computer-readable capturing medium having captured therein a classification tree generation program causing a computer to execute:
a first computation process for computing, when a new classification condition to be added to a classification tree, which is a prediction model expressed in a tree structure formed from one or more nodes representing classification conditions is selected from a plurality of classification condition candidates, information gain relating to the classification condition candidate, for each of the classification condition candidates respectively;
a second computation process for computing, as a cost relating to the classification condition candidate, a value representing the magnitude of the smallest difference among differences between the classification condition candidate and each of the classification conditions included in the classification tree, for each of the classification condition candidates respectively; and
a selection process for selecting, as the new classification condition, the classification condition candidate from among the plurality of classification condition candidates that has the largest value among values obtained by subtracting the computed cost from the computed information gain.

12. (canceled)

13. The computer-implemented classification tree generation method according to claim 2, further comprising
computing, according to content of classification condition candidate, the cost relating to the classification condition candidate.

14. The computer-implemented classification tree generation method according to claim 2, further comprising:
generating a logic circuit representing a system that performs a prediction process using the classification tree; and
computing the cost relating to the classification condition candidate according to an AND circuit included in the generated logic circuit.

15. The computer-implemented classification tree generation method according to claim 3, further comprising:
generating a logic circuit representing a system that performs a prediction process using the classification tree; and
computing the cost relating to the classification condition candidate according to an AND circuit included in the generated logic circuit.

16. The computer-implemented classification tree generation method according to claim 13, further comprising:
generating a logic circuit representing a system that performs a prediction process using the classification tree; and
computing the cost relating to the classification condition candidate according to an AND circuit included in the generated logic circuit.

17. The computer-implemented classification tree generation method according to claim 2, further comprising
changing the weight of the computed cost to be subtracted from information gain computed according to the depth of the classification tree or the number of the classification conditions included in the classification tree.

18. The computer-implemented classification tree generation method according to claim 3, further comprising
changing the weight of the computed cost to be subtracted from information gain computed according to the depth of the classification tree or the number of the classification conditions included in the classification tree.

19. The computer-implemented classification tree generation method according to claim 4, further comprising
changing the weight of the computed cost to be subtracted from information gain computed according to the depth of the classification tree or the number of the classification conditions included in the classification tree.

20. The computer-implemented classification tree generation method according to claim 13, further comprising
changing the weight of the computed cost to be subtracted from information gain computed according to the depth of the classification tree or the number of the classification conditions included in the classification tree.

21. The computer-implemented classification tree generation method according to claim 14, further comprising
changing the weight of the computed cost to be subtracted from information gain computed according to the depth of the classification tree or the number of the classification conditions included in the classification tree.

22. The computer-implemented classification tree generation method according to claim 15, further comprising
changing the weight of the computed cost to be subtracted from information gain computed according to the depth of the classification tree or the number of the classification conditions included in the classification tree.

23. The computer-implemented classification tree generation method according to claim 16, further comprising
changing the weight of the computed cost to be subtracted from information gain computed according to the depth of the classification tree or the number of the classification conditions included in the classification tree.

24. The computer-implemented classification tree generation method according to claim 2, further comprising
changing the weight of the computed cost to be subtracted from information gain computed according to the processing capacity of the system that performs the prediction process using the classification tree.

25. The computer-implemented classification tree generation method according to claim 3, further comprising
changing the weight of the computed cost to be subtracted from information gain computed according to the processing capacity of the system that performs the prediction process using the classification tree.

26. The computer-implemented classification tree generation method according to claim 4, further comprising
changing the weight of the computed cost to be subtracted from information gain computed according to the processing capacity of the system that performs the prediction process using the classification tree.

27. The computer-implemented classification tree generation method according to claim 5, further comprising
changing the weight of the computed cost to be subtracted from information gain computed according to the processing capacity of the system that performs the prediction process using the classification tree.

28. The computer-implemented classification tree generation method according to claim 13, further comprising
changing the weight of the computed cost to be subtracted from information gain computed according to the processing capacity of the system that performs the prediction process using the classification tree.

29. The computer-implemented classification tree generation method according to claim 14, further comprising
changing the weight of the computed cost to be subtracted from information gain computed according to the processing capacity of the system that performs the prediction process using the classification tree.

30. The computer-implemented classification tree generation method according to claim 15, further comprising
changing the weight of the computed cost to be subtracted from information gain computed according to the processing capacity of the system that performs the prediction process using the classification tree.

31. The computer-implemented classification tree generation method according to claim 16, further comprising
changing the weight of the computed cost to be subtracted from information gain computed according to the processing capacity of the system that performs the prediction process using the classification tree.
